(19) United States
(12) Patent Application Publication
(10) Pub. No.: US 2024/0244627 A1
(43) Pub. Date: Jul. 18, 2024

(54) TERMINAL, RADIO COMMUNICATION SYSTEM AND RADIO COMMUNICATION METHOD

(71) Applicant: NTT DOCOMO, INC., Tokyo (JP)

(72) Inventors: Yuki Takahashi, Tokyo (JP); Satoshi Nagata, Tokyo (JP); Qiping Pi, Beijing (CN); Jing Wang, Beijing (CN); Lan Chen, Beijing (CN)

(73) Assignee: NTT DOCOMO, INC., Tokyo (JP)

(21) Appl. No.: 18/562,168

(22) PCT Filed: Mar. 30, 2022
(86) PCT No.: PCT/JP2022/015892

§ 371 Date: Nov. 17, 2023

(30) Foreign Application Priority Data
May 20, 2021 (JP) 2021-085238

(51) Int. Cl. H04W 72/21; H04W 72/044; H04W 72/563

(52) U.S. Cl. CPC H04W 72/21; H04W 72/0473; H04W 72/563

(57) ABSTRACT

A terminal comprising: a transmission unit that transmits one or more uplink channels; and a control unit that multiplexes the one or more uplink channels; wherein the control unit determines the one or more uplink channels based on a specific priority so that a transmission power of the one or more uplink channels is smaller than a specific power; and the specific priority is defined based on at least one of a condition among a priority of an uplink channel, a type of the uplink channel, a priority of uplink control information transmitted through the uplink channel, and a type of the uplink control information.

### TECHNICAL FIELD

The present disclosure relates to a terminal, a base station and a radio communication method for performing radio communication, in particular, a terminal, a radio communication system and a radio communication method related to multiplexing of uplink channels.

### BACKGROUND ART

The 3rd Generation Partnership Project (3GPP) has specified the 5th generation mobile communication system (Also called 5G, New Radio (NR), or Next Generation (NG)) and is also in the process of specifying the next generation called Beyond 5G, 5G Evolution or 6G.

Release 15 of 3GPP supports multiplexing of two or more uplink channels (PUCCH (Physical Uplink Control Channel) and PUSCH (Physical Uplink Shared Channel)) sent in the same slot.

In addition, Release 17 of 3GPP agreed to support multiplexing Uplink Control Information (UCI) with different priorities into PUCCH or PUSCH (For example, Non-Patent Literature 1).

### CITATION LIST

### Non-Patent Literature

### [Non-Patent Literature 1]

“Enhanced Industrial Internet of Things (IOT) and ultra-reliable and low latency communication,” RP-201310, 3GPP TSG RAN Meeting #86e, 3GPP, July 2020

### SUMMARY OF INVENTION

### Issues to be Solved by the Invention

Against this background, the inventors, etc. have found, as a result of careful examination, that in a case where one or more uplink channels (PUCCH/PUSCH) are multiplexed, it is necessary to determine one or more uplink channels so that the transmission power of one or more uplink channels is smaller than the specified power, and it is necessary to set a priority order for determining one or more uplink channels.

Accordingly, the present invention has been made in view of such a situation, and it is an object of the present invention to provide a terminal, a radio communication system, and a radio communication method capable of appropriately determining one or more uplink channels so that the transmission power of the one or more uplink channels becomes smaller than a specific power when the one or more uplink channels are multiplexed.

### Means for Solving the Problem

An aspect of disclosure is a terminal comprising: a transmission unit that transmits one or more uplink channels; and a control unit that multiplexes the one or more uplink channels; wherein the control unit determines the one or more uplink channels based on a specific priority so that a transmission power of the one or more uplink channels is smaller than a specific power; and the specific priority is defined based on at least one of a condition among a priority of an uplink channel, a type of the uplink channel, a priority of uplink control information transmitted through the uplink channel, and a type of the uplink control information.

An aspect of the present disclosure is a radio communication system comprising: a terminal; and a base station; wherein the terminal comprises: a transmission unit that transmits one or more uplink channels; and a control unit that multiplexes the one or more uplink channels; wherein the control unit determines the one or more uplink channels based on a specific priority so that a transmission power of the one or more uplink channels is smaller than a specific power; and the specific priority is defined based on at least one of a condition among a priority of an uplink channel, a type of the uplink channel, a priority of uplink control information transmitted through the uplink channel, and a type of the uplink control information.

An aspect of the present disclosure is a radio communication method comprising: a step A of transmitting one or more uplink channels; and a step B of multiplexing the one or more uplink channels; wherein the step B includes a step of determining the one or more uplink channels based on a specific priority so that a transmission power of the one or more uplink channels is smaller than a specific power; and the specific priority is defined based on at least one of a condition among a priority of an uplink channel, a type of the uplink channel, a priority of uplink control information transmitted through the uplink channel, and a type of the uplink control information.

### BRIEF DESCRIPTION OF DRAWINGS

FIG. 1 is a general schematic diagram of the radio communication system 10.

FIG. 2 is a diagram showing the frequency range used in the radio communication system 10.

FIG. 3 is a diagram showing a configuration example of a radio frame, a sub-frame and a slot used in the radio communication system 10.

FIG. 4 is a functional block configuration diagram of the UE200.

FIG. 5 is a functional block configuration diagram of the gNB100.

FIG. 6 is a diagram for explaining operation example 1.

FIG. 7 is a diagram for explaining operation example 1.

FIG. 8 is a diagram for explaining operation example 2.

FIG. 9 is a diagram for explaining operation example 2.

FIG. 10 shows an example of a hardware configuration of the gNB100 and the UE200.

### MODES FOR CARRYING OUT THE INVENTION

Exemplary embodiments of the present invention are explained below with reference to the accompanying drawings. The same functions and structures are denoted by the same or similar reference numerals, and their descriptions are omitted accordingly.

### Embodiments

### (1) Overall Schematic Configuration of Radio Communication System

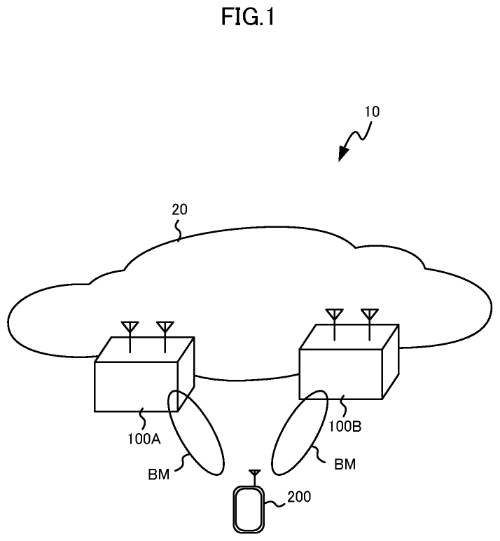

FIG. 1 is an overall schematic configuration diagram of a radio communication system 10 according to an embodiment. the radio communication system 10 is a radio communication system according to 5G New Radio (NR) and includes a Next Generation-Radio Access Network 20 (hereinafter referred to as NG-RAN20 and a terminal 200 (UE (User Equipment) 200).

The radio communication system 10 may be a radio communication system according to a system called Beyond 5G, 5G Evolution or 6G.

The NG-RAN20 includes a radio base station 100 A (gNB100A) and a radio base station 100B (gNB100B0B). The specific configuration of the radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5G. Note that the NG-RAN20 and 5GC may be referred to simply as “networks”.

The gNB100A and gNB100B are radio base stations in accordance with 5G, and perform radio communications in accordance with the UE200 a and 5G. The gNB100A, gNB100B, and UE200 can support Massive MIMO (Multiple-Input Multiple-Output), which generates a more directional beam BM by controlling radio signals transmitted from multiple antenna elements; Carrier Aggregation (CA), which uses multiple component carriers (CCs) bundled together; and Dual Connectivity (DC), which communicates with two or more transport blocks simultaneously between the UE and each of two NG-RAN Nodes.

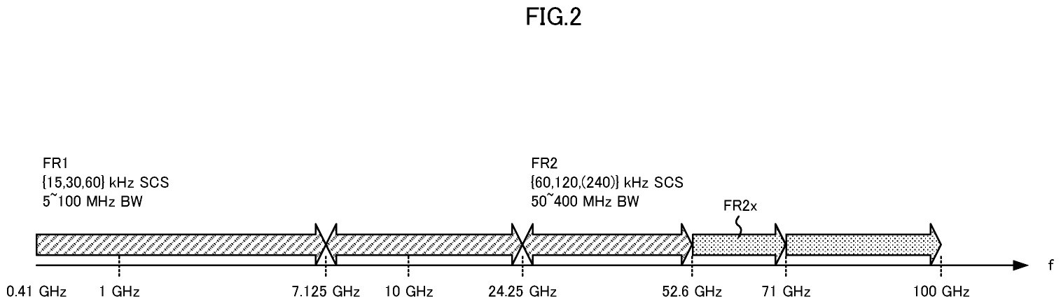

The radio communication system 10 also supports multiple frequency ranges (FRs). FIG. 2 shows the frequency ranges used in radio communication system 10.

As shown in FIG. 2, the radio communication system 10 corresponds to FR1 FRand FR2. The frequency bands of each FR are as follows.
FR1:410 MHz˜7.125 GHz
FR2:24.25 GHz˜52.6 GHz

FR1 uses 15, 30 or 60 kHz sub-carrier spacing (SCS) and may use a 5˜100 MHz bandwidth (BW). FR2 is higher frequency than FR1 and may use 60 or 120 kHz (may include 240 kHz) SCS and may use a 50˜400 MHZ bandwidth (BW).

SCS may be interpreted teas numerology. Numerology is defined in 3GPP TS38.300 and corresponds to one subcarrier interval in the frequency domain.

In addition, the radio communication system 10 corresponds to a higher frequency band than the frequency band of FR2. Specifically, the radio communication system 10 corresponds to a frequency band exceeding 52.6 GHz and up to 71 GHz or 114.25 GHz. Such a high frequency band may be referred to as “FR 2 x” for convenience.

In order to solve the problem that the influence of phase noise increases in the high frequency band, a cyclic prefix-orthogonal frequency division multiplexing (CP-OFDM)/discrete Fourier transform-spread (DFT-S-OFDM) with a larger sub-carrier spacing (SCS) may be applied when a band exceeding 52.6 GHz is used.

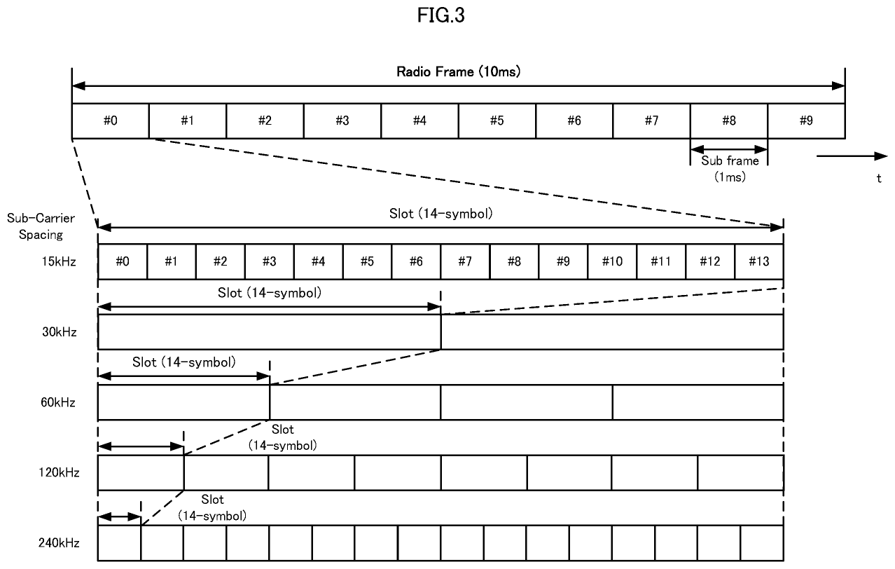

FIG. 3 shows a configuration example of a radio frame, a sub-frame and a slot used in the radio communication system 10.

As shown in FIG. 3, a slot consists of 14 symbols, and the larger (wider) the SCS, the shorter the symbol per period (and slot period). The SCS is not limited to the interval (frequency) shown in FIG. 3. For example, 480 kHz, 960 kHz, and the like may be used.

The number of symbols constituting 1 slot may not necessarily be 14 symbols (For example, 28, 56 symbols). Furthermore, the number of slots per subframe may vary depending on the SCS.

Note that the time direction (t) shown in FIG. 3 may be referred to as a time domain, symbol period, symbol time, etc. The frequency direction may be referred to as a frequency domain, resource block, subcarrier, bandwidth part (BWP), etc.

A DMRS is a type of reference signal and is prepared for various channels. In this context, unless otherwise specified, a DMRS for a downlink data channel, specifically a PDSCH (Physical Downlink Shared Channel), may be used. However, a DMRS for an uplink data channel, specifically a PUSCH (Physical Uplink Shared Channel), may be interpreted in the same way as a DMRS for a PDSCH.

The DMRS may be used for channel estimation in a device, e.g., UE200, as pas rt of a coherent demodulation. The DMRS may be present only in the resource block (RB) used for PDSCH transmission.

The DMRS may have more than one mapping type. Specifically, the DMRS may have a mapping type A and a mapping type B. In a mapping type A, the first DMRS is located in the second or third symbol of the slot. In a mapping type A, the DMRS may be mapped relative to the slot boundary regardless of where the actual data transmission is initiated in the slot. The reason why the first DMRS is placed in the second or third symbol of the slot may be interpreted as placing the first DMRS after the control resource sets (CORESET).

In mapping type B, the first DMRS may be placed in the first symbol of the data allocation. That is, the location of the DMRS may be given relative to where the data is located, rather than a relative to the slot boundary.

The DMRS may also have more than one type. Specifically, the DMRS may have Type 1 and Type 2. Type 1 and Type 2 differ in the maximum number of mapping and orthogonal reference signals in the frequency domain. Type 1 can output up to four orthogonal signals in single-symbol DMRS, and Type 2 can output up to eight orthogonal signals in double-symbol DMRS.

### (2) Radio Communication System Functional Block Configuration

Next, a functional block configuration of the radio communication system 10 will be described.

First, a functional block configuration of the UE200 will be described.

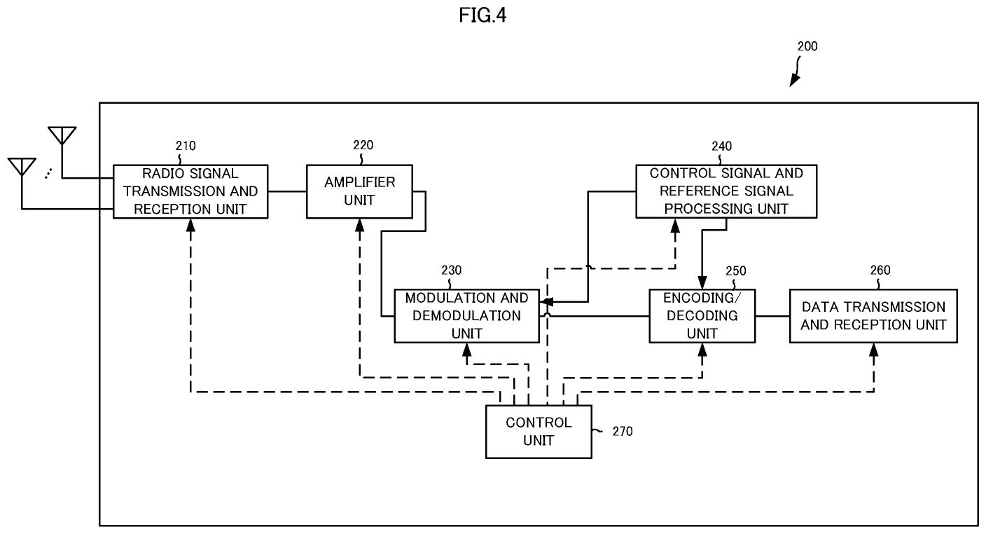

FIG. 4 is a functional block configuration diagram of the UE200. As shown in FIG. 4, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

The radio signal transmission and reception unit 210 transmits and receives radio signals in accordance with the NR. the radio signal transmission and reception unit 210 corresponds to a Massive MIMO, a CA using a plurality of CCs bundled together, and a DC that simultaneously communicates between a UE and each of two NG-RAN Nodes.

The amplifier unit 220 is composed of a PA (Power Amplifier)/LNA (Low Noise Amplifier) or the like. the amplifier unit 220 amplifies the signal output from the modulation and demodulation unit 230 to a predetermined power level. the amplifier unit 220 amplifies the RF signal output from radio signal transmission and reception unit 210.

The modulation and demodulation unit 230 performs data modulation/demodulation, transmission power setting, resource block allocation, etc. for each predetermined communication destination (gNB100 or other gNB). In the modulation and demodulation unit 230, Cyclic Prefix-Orthogonal Frequency Division Multiplexing (CP-OFDM)/Discrete Fourier Transform-Spread (DFT-S-OFDM) may be applied. DFT-S-OFDM may be used not only for the uplink (UL) but also for the downlink (DL).

The control signal and reference signal processing unit 240 performs processing related to various control signals transmitted and received by the UE200 and various reference signals transmitted and received by the UE200.

Specifically, the control signal and reference signal processing unit 240 receives various control signals transmitted from the gNB100 via a predetermined control channel, for example a radio resource control layer (RRC) control signal. the control signal and reference signal processing unit 240 also transmits various control signals to the gNB100 via a predetermined control channel.

The control signal and reference signal processing unit 240 executes processing using a reference signal (RS) such as a demodulation reference signals (DMRS) and a phase tracking reference signal (PTRS).

The DMRS is a known reference signal (pilot signal) between a base station and a terminal of each terminal for estimating a fading channel used for data demodulation. The PTRS is a reference signal of each terminal for estimating phase noise, which is a problem in a high frequency band.

In addition to the DMRS and the PTRS, the reference signal may include a Channel State Information-Reference Signal (CSI-RS), a Sounding Reference Signal (SRS), and a Positioning Reference Signal (PRS) for position information.

The channel may include a control channel and a data channel. The control channel may include PDCCH (Physical Downlink Control Channel), PUCCH (Physical Uplink Control Channel), RACH (Random Access Channel), Downlink Control Information (DCI) including Random Access Radio Network Temporary Identifier (RA-RNTI), and Physical Broadcast Channel (PBCH).

The data channels include PDSCH (Physical Downlink Shared Channel) and PUSCH (Physical Uplink Shared Channel). Data means data transmitted over a data channel. A data channel may be read as a shared channel.

Here, the control signal and reference signal processing unit 240 may receive downlink control information (DCI). The DCI includes existing fields for storing DCI Formats, Carrier indicator (CI), BWP indicator, Frequency Domain Resource Assignment (FDRA), Time Domain Resource Assignment (TDRA), Modulation and Coding Scheme (MCS), HPN (HARQ Process Number), New Data Indicator (NDI), Redundancy Version (RV), and the like.

The value stored in the DCI Format field is an information element that specifies the format of the DCI. The value stored in the CI field is an information element that specifies the CC to which the DCI applies. The value stored in the BWP indicator field is an information element that specifies the BWP to which the DCI applies. The BWP that can be specified by the BWP indicator is set by an information element (Bandwidth Part-Config) contained in the RRC message. The value stored in the FDRA field is an information element that specifies the frequency domain resource to which the DCI applies. The frequency domain resource is specified by the value stored in the FDRA field and the information element (RA Type) contained in the RRC message. The value stored in the TDRA field is the information element that specifies the time domain resource to which the DCI is applied. The time domain resource is specified by the value stored in the TDRA field and the information element (pdsch-TimeDomainAllocationList, pusch-TimeDomainAllocationList) contained in the RRC message. The time domain resource may be specified by the value stored in the TDRA field and the default table. The value stored in the MCS field is an information element that specifies the MCS to which the DCI applies. The MCS is specified by the value stored in the MCS and the MCS table. The MCS table may be specified by an RRC message or specified by RNTI scrambling. The value stored in the HPN field is an information element that specifies the HARQ Process to which the DCI is applied. The value stored in the NDI is an information element that identifies whether the data to which the DCI is applied is first-time data. The value stored in the RV field is an information element that specifies the redundancy of the data to which the DCI applies.

The encoding/decoding unit 250 performs data partitioning/concatenation and channel coding/decoding for each predetermined communication destination (gNB100 or other gNB).

Specifically, the encoding/decoding unit 250 divides the data output from the data transmission and reception unit 260 into predetermined sizes and performs channel coding for the divided data. the encoding/decoding unit 250 decodes the data output from the modulation and demodulation unit 230 and concatenates the decoded data.

The data transmission and reception unit 260 transmits and receives the protocol data unit (PDU) and the service data unit (SDU). Specifically, the data transmission and reception unit 260 performs assembly/disassembly of the PDUs/SDUs in a plurality of layers (Media access control layer (MAC), radio link control layer (RLC), packet data convergence protocol layer (PDCP), etc.). the data transmission and reception unit 260 also performs error correction and retransmission control of data based on HARQ (Hybrid Automatic Repeat Request).

The control unit 270 controls each functional block constituting the UE200. In the embodiment, the control unit 270 constitutes a control unit that multiplexes one or more uplink channels (UL channel). the control unit 270 determines one or more uplink channels based on a specific priority so that the transmission power of one or more uplink channels is smaller than a specific power. the control unit 270 controls the control signal and reference signal processing unit 240, and the control signal and reference signal processing unit 240 constitutes transmission unit that transmits one or more uplink channels (UL channels).

Specifically, the control unit 270 determines the UL channel to be transmitted by the transmission occasion i based on the specific priority so that the total transmission power of the UE200 for the UL channel (PUSCH, PUCCH, PRACH, SRS, etc.) to be transmitted by each transmission occasion i of the serving cell in the frequency range is smaller than the specific power (PCMAN (i)).

The specific priority is defined based on at least one of the following conditions: priority of the UL channel, type of UL channel, priority of uplink control information (UCI) transmitted over the UL channel, and type of UCI.

Here, two types of priority of the UL channel, HP (High Priority) and LP (Low Priority), will be exemplified. Three or more types of priority may be specified as the priority of the UL channel. PUCCH and PUSCH are exemplified as the types of the UL channel. HP (High Priority) and LP (Low Priority) are exemplified as the priority of the UCI. Three or more types of priority may be specified as the priority of the UCI. Examples of UCI types are HARQ-ACK, SR (Scheduling Request), LRR (LINK Recovery Request), and CSI (Channel State Indicator).

Note that the control unit 270 controls the control signal and reference signal processing unit 240 described above, and the control signal and reference signal processing unit 240 transmits the UL channel determined based on the specific priority via the second PUSCH. The transmission of the UL channel may be read as the transmission of a signal through the UL channel.

Second, the functional block configuration of the gNB100 will be described.

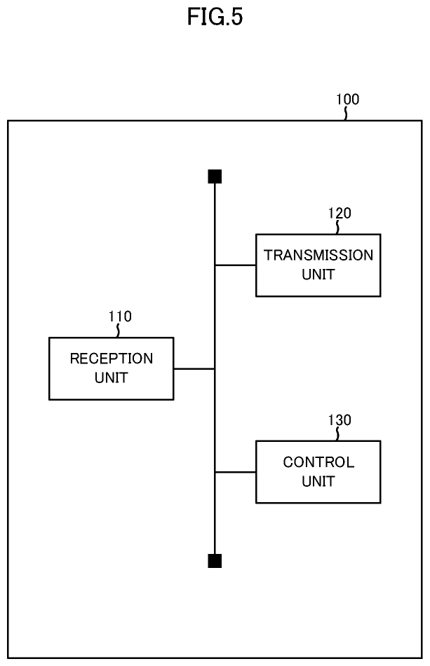

FIG. 5 is a functional block configuration diagram of the gNB100. As shown in FIG. 5, the gNB100 has a reception unit 110, a transmission unit 120, and a control unit 130.

The reception unit 110 receives various signals from the UE200. The reception unit 110 may receive UL signals via PUCCH or PUSCH.

The transmission unit 120 transmits various signals to the UE200. The transmission unit 120 may transmit DL signals via PDCCH or PDSCH. The control unit 130 controls the gNB100. The control unit 130 assumes the reception unit 110 receives the UL channel determined based on the specific priority. The reception of the UL channel may be read as the reception of a signal via the UL channel.

### (3) Specific Priority

Specific priority of embodiments will be described below. As described above, specific priority is defined based on at least one of the following conditions: UL channel priority, UL channel type, UCI priority, and UCI type.

The priority of the UL channel may be referred to as the PHY priority. For example, the PHY priority may be HP and LP. The PHY priority may be based on the following options:

In option 1, the PHY priority may be determined independently of multiplexing for UL channels.

Specifically, for PUSCH, the PHY priority for UL channels may be a priority informed by DCI or set by RRC configuration.

For PUCCH, the PHY priority for UL channels may be a priority in the configuration of the transmission PUCCH resource (PUSCH-Config).

Option 2 may be set in consideration of multiplexing with respect to UL channels.

Specifically, for PUSCH, the PHY priority of the UL channel may be determined to be “HP” if the conditions of the following set of conditions are satisfied. The PHY priority of the UL channel may be determined to be “LP” if the conditions of the following set of conditions are not satisfied. The set of conditions may include one or more of the following conditions:

The first condition may be a condition in which the PUSCH is reported to be HP by the DCI, or a condition in which the PUSCH is set to be HP by the RRC configuration. The second condition may be a condition in which the HP UCI is multiplexed on the PUSCH. The third condition may be a condition in which the specific HP UCI (For example, HP HARQ-ACK) is multiplexed on the PUSCH. Specific HP UCIs may be predefined in the radio communication system 10 and may be configured with RRC settings.

Whether the condition set for determining HP includes the first condition, the second condition, or the third condition may be predefined in the radio communication system 10 and may be configured with RRC settings.

For PUCCH, the PHY priority of the UL channel may be determined to be “HP” if the following condition set conditions are satisfied. The PHY priority of the UL channel may be determined to be “LP” if the following condition set conditions are not satisfied. The condition set may include one or more of the following conditions:

The first condition may be a condition where the transmission PUCCH resource is included in the PUCCH resource configured by PUSCH-Config for HP. The second condition may be a condition where the HP UCI is included in the PUCCH. The third condition may be one in which a specific HP UCI (For example, HP HARQ-ACK) is included in the PUCCH. The specific HP UCI may be predefined in the radio communication system 10 and may be set by an RRC setting.

Whether the condition set for determining HP includes the first condition, the second condition, or the third condition may be predefined in the radio communication system 10 and may be set by an RRC setting.

The type of the UL channel may be whether the UL channel is PUCCH or PUSCH. Although not particularly limited, PRACH may be considered to have higher priority than PUCCH and PUSCH. SRS may be considered to have lower priority than PUCCH and PUSCH. In embodiments, the types of UL channels will be described primarily for PUCCH and PUSCH.

The priority of the UCI may be HP and LP. The specific priority may be defined by whether the HP UCI is included in the uplink channel (multiplexed or not). The specific priority may be defined by whether the LP UCI is included in the uplink channel (multiplexed or not). The priority of the UCI may be predefined in the radio communication system 10 and may be set by RRC settings.

The type of UCI may be one or more types selected from among HARQ-ACK, SR, LRR and CSI. The specific priority may be defined by whether the UCI is HP HARQ-ACK, whether the UCI is HP SR, whether the UCI is HP LRR, and whether the UCI is HP CSI. Alternatively, the specific priority may be defined by whether the UCI is LP HARQ-ACK, whether the UCI is LP SR, whether the UCI is LP LRR, and whether the UCI is LP CSI.

### (3.1) Example 1

In operation example 1, the specific priority may be defined by a combination of two or more conditions. The specific priority may be defined based on a condition that determines one or more UL channels based on the priority of the UL channels and then determines one or more UL channels based on other conditions. The other conditions may include at least one of the following conditions: UL channel type, UCI priority, and UCI type. One or more UL channels are determined such that the transmit power of one or more UL channels is less than the specified power.

For example, if the transmit power of the UE200 exceeds the specified power, one or more UL channels may be determined based on the priority of the UL channels. Subsequently, if the transmit power of the UL channels having the same priority exceeds the specified power, one or more UL channels may be determined based on the priority (For example, whether the UL channel contains an HP UCI or not, and whether the UL channel contains an LP UCI or not) of the UCI included in the UL channels for the UL channels having the same priority. Subsequently, if the transmit power of the UL channels determined based on the priority of the UCI exceeds the specified power, one or more UL channels may be determined based on the type of UCI for the UL channels determined based on the priority of the UCI.

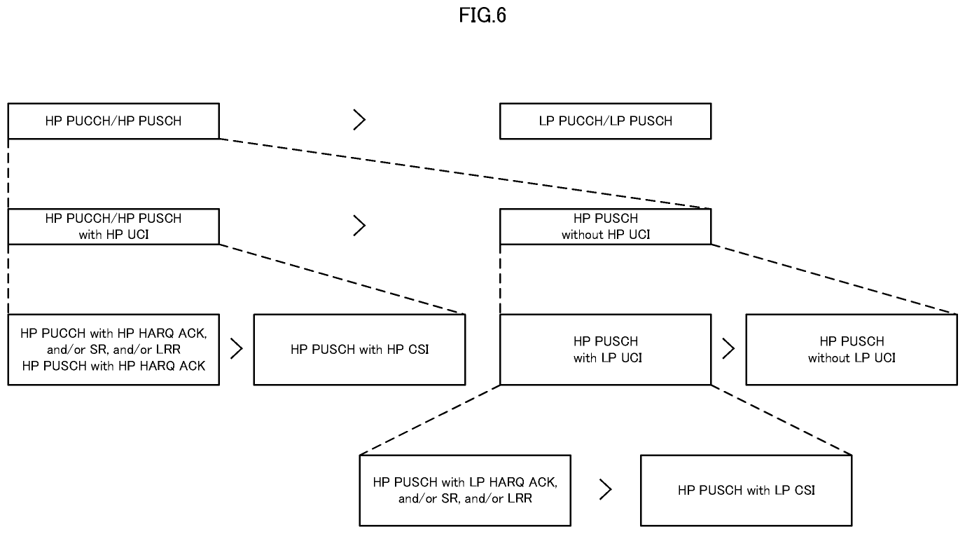

First, as shown in FIG. 6, if the transmit power of the UE200 exceeds the specified power, the priority of the HP PUCCH/HP PUSCH may be higher than that of the LP PUCCH/LP PUSCH.

If the transmit power of HP PUCCH/HP PUSCH exceeds the specified power, the priority of HP PUCCH/HP PUSCH with HP UCI may be higher than that of HP PUSCH with LP UCI.

If the transmit power of HP PUCCH/HP PUSCH with HP UCI exceeds the specified power, the priority of HP PUCCH with HP HARQ-ACK (and/or SR and/or LRR) and HP PUSCH with HP HARQ-ACK may be higher than that of HP PUSCH with HP CSI.

If the transmit power of HP PUSCH without HP UCI is added and the transmit power of UE200 exceeds the specified power, the priority of HP PUSCH with LP UCI may be higher than that of HP PUSCH without LP UCI.

If the transmit power of HP PUSCH with LP UCI is added and the transmit power of UE200 exceeds the specified power, the priority of HP PUSCH with LP HARQ-ACK (and/or SR and/or LRR) may be higher than that of HP PUSCH with LP CSI.

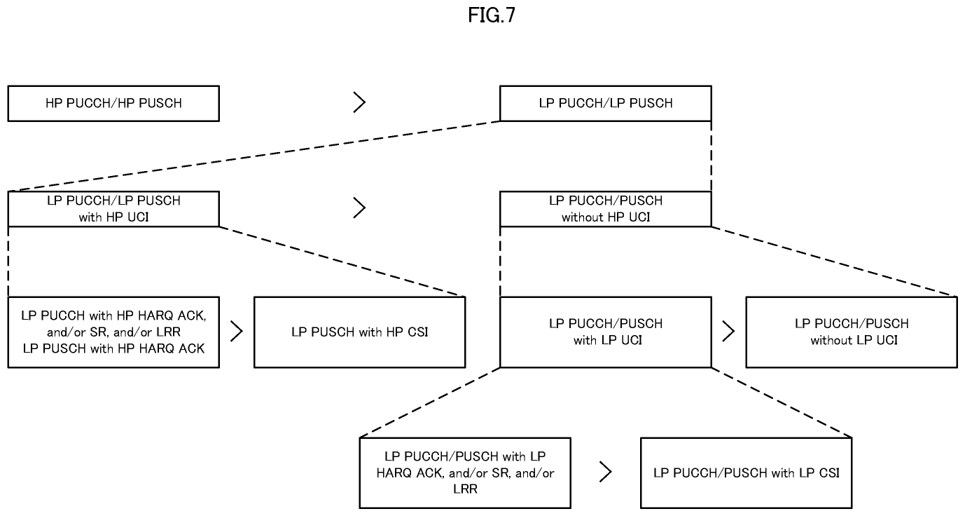

Second, as shown in FIG. 7, when the transmit power of HP PUCCH/HP PUSCH is lower than the specified power or when there is no HP PUCCH/HP PUSCH, the priority of LP PUCCH/LP PUSCH with HP UCI may be higher than that of PUCCH/PUSCH with LP UCI.

When the transmit power of LP PUCCH/LP PUSCH with HP UCI is added, the priority of LP PUCCH/LP PUSCH with HP HARQ-ACK (and/or SR and/or LRR) may be higher than that of PUCCH/PUSCH with HP CSI if the transmit power of UE200 exceeds the specified power.

When the transmit power of LP PUCCH/LP PUSCH without HP UCI is added, the priority of LP PUCCH/LP PUSCH with LP UCI may be higher than that of LP PUCCH/LP PUSCH without LP UCI if the transmit power of UE200 exceeds the specified power.

When the transmit power of LP PUCCH/LP PUSCH with LP UCI is added, the priority of LP PUCCH with LP HARQ-ACK (and/or SR and/or LRR) and LP PUSCH with LP HARQ-ACK may be higher than that of LP PUCCH/LP PUSCH with LP CSI if the transmit power of UE200 exceeds the specified power.

### (3.2) Example 2

In Example 2, the specific priority may be defined by a combination of two or more conditions. The specific priority may be defined based on a condition that determines one or more UL channels based on the priority of the UCI and then determines one or more UL channels based on other conditions. Other conditions may include at least one of UL channel priority, UL channel type and UCI type. One or more UL channels are determined such that the transmit power of one or more UL channels is less than the specified power.

First, if the transmit power of the UE200 exceeds the specified power, one or more UL channels may be determined from among the UL channels including the HP UCI. Subsequently, if the transmit power of the UL channels including the HP UCI exceeds the specified power, one or more UL channels may be determined for the UL channels including the HP UCI with the following options:

In the first option, one or more UL channels may be determined based on the type of HP UCI included in the UL channels.

In the second option, one or more UL channels may be determined based on the priority of the UL channels.

In the third option, one or more UL channels may be determined based on whether the UL channel includes an LP UCI.

In the fourth option, one or more UL channels may be determined based on the type of UCI when the UL channel includes an LP UCI.

Note that two or more options selected from the first option, the second option, the third option, and the fourth option may be combined. For example, when the first option and the second option are combined, the first option may be applied before the second option, and the second option may be applied before the first option.

Second, when the transmission power of the UE200 exceeds the specified power, one or more UL channels may be determined from among the UL channels including the LP UCI. When the transmission power of the UL channels including the HP UCI exceeds the specified power, or when there is no UL channel including the HP UCI, one or more UL channels may be determined from among the UL channels including the LP UCI. Subsequently, when the transmission power of the UL channels including the LP UCI exceeds the specified power, one or more UL channels may be determined for the UL channels including the LP UCI with the following options:

In the first option, one or more UL channels may be determined based on the priority of the UL channels.

In the second option, one or more UL channels may be determined based on whether the UL channels include LP UCIs.

In the third option, one or more UL channels may be determined based on the type of LP UCI when the UL channels include LP UCIs.

Note that two or more options selected from the first option, the second option, and the third option may be combined. For example, when the first option, the second option, and the third option are combined, the first option may be applied before the second option, and the second option may be applied before the third option. Alternatively, the second option may be applied before the first option, and the first option may be applied before the third option.

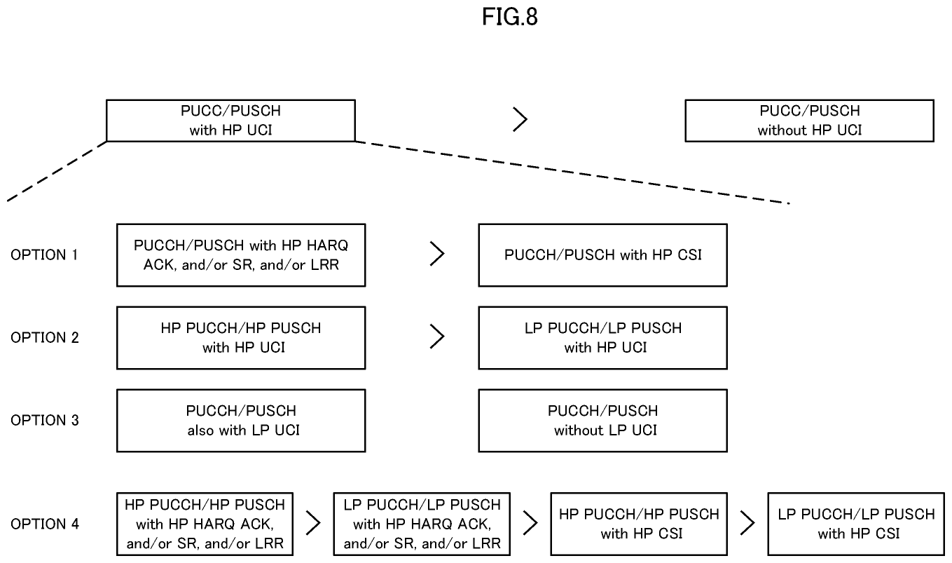

First, as shown in FIG. 8, when the transmission power of the UE200 exceeds the specified power, the priority of the PUCCH/PUSCH including the HP UCI may be higher than that of the PUCCH/PUSCH not including the HP UCI.

When the transmission power of the PUCCH/PUSCH including the HP UCI exceeds the specified power, the following options may be adopted. In the first option, the priority of the PUCCH/PUSCH including the HP HARQ-ACK (and/or SR and/or LRR) may be higher than the priority of the PUCCH/PUSCH including the HP CSI.

In the second option, the priority of the HP PUCCH/PUSCH may be higher than the priority of the LP PUCCH/PUSCH.

In the third option, the priority of the PUCCH/PUSCH with the LP UCI may be higher than the priority of the PUCCH/PUSCH without the LP UCI.

In the fourth option, the first option and the second option may be combined. For example, the priority of HP PUCCH/HP PUSCH including HP HARQ-ACK (and/or SR and/or LRR) may be higher than the priority of LP PUCCH/LP PUSCH including HP HARQ-ACK (and/or SR and/or LRR). The priority of LP PUCCH/LP PUSCH including HP HARQ-ACK (and/or SR and/or LRR) may be higher than the priority of HP PUCCH/HP PUSCH including HP CSI. The priority of HP PUCCH/HP PUSCH including HP CSI may be higher than the priority of LP PUCCH/LP PUSCH including HP CSI.

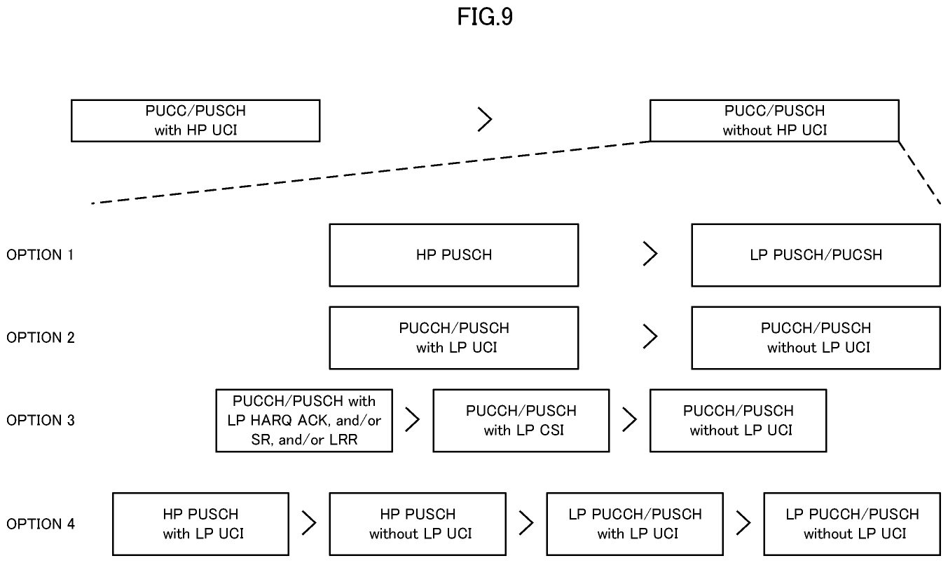

Second, as shown in FIG. 9, when the transmit power of PUCCH/PUSCH including HP UCI is less than the specified power, or when there is no PUCCH/PUSCH including HP UCI, the following options may be employed.

In the first option, the priority of HP PUSCH may be higher than that of LP PUCCH/PUSCH.

In the second option, the priority of PUCCH/PUSCH with LP UCI may be higher than that of PUCCH/PUSCH without LP UCI.

In the third option, the priority of PUCCH/HP PUSCH with LP HARQ-ACK (and/or SR and/or LRR) may be higher than that of PUCCH/HP PUSCH with LP CSI. The priority of PUCCH/HP PUSCH with LP CSI may be higher than that of PUCCH/HP PUSCH without LP UCI.

In the fourth option, the first option and the second option may be combined. For example, the priority of HP PUSCH with LP UCI may be higher than that of HP PUSCH without LP UCI. The priority of HP PUSCH without LP UCI may be higher than that of LP PUCCH/LP PUSCH with LP UCI. The priority of LP PUCCH/LP PUSCH with LP UCI may be higher than that of LP PUCCH/LP PUSCH without LP UCI.

### (4) Operation and Effect

In the embodiment, the UE200 determines one or more uplink channels based on a specific priority so that the transmit power of one or more UL channels is less than the specific power. The specific priority is defined by at least one of UL channel priority, UL channel type, UCI priority, and UCI type. According to such a configuration, since the specific priority used to make the transmission power of the UE200 smaller than the specific power is defined, one or more UL channels can be appropriately determined even when a plurality of one or more UL channels is assumed.

### (5) Other Embodiments

Although the contents of the present invention have been described in accordance with the above embodiments, it is obvious to those skilled in the art that the present invention is not limited to these descriptions but can be modified and improved in various ways.

Although not specifically mentioned in the foregoing disclosure, the application of any of the above options may be set by upper layer parameters, reported by UE Capability of UE 200, or predetermined by the radio communication system 10. In addition, the application of any of the above options may be determined by upper layer parameters and UE Capability.

Here, UE Capability may include the following information elements:

First, UE Capability may include an information element that defines whether it is capable of multiplexing two or more UL channels (PUCCH or PUSCH) with different priorities.

Second, UE Capability may include an information element that defines whether it is capable of reducing transmission power based on a specific priority defined by the priority of the UL channel.

Third, UE Capability may include an information element that defines whether it is capable of reducing transmission power based on a specific priority defined by the priority of the UCI. The priority of the UCI may be defined by whether or not it includes an HP UCI and may be defined by whether or not it includes an LP UCI.

Fourth, the UE Capability may include an information element that defines whether the UE Capability corresponds to transmit power reduction based on a specific priority defined by the type of UCI. The type of UCI may be defined by the type of HP UCI or by the type of LP UCI.

Fifth, UE Capability may include an information element that defines whether the UE Capability corresponds to transmit power reduction based on a specific priority defined by the type of UL channel.

The block configuration diagrams (FIGS. 4 and 5) used to describe the embodiments described above illustrate blocks of functional units. Those functional blocks (structural components) can be realized by a desired combination of at least one of hardware and software. Means for realizing each functional block is not particularly limited. That is, each functional block may be implemented using a single device that is physically or logically coupled, or two or more devices that are physically or logically separated may be directly or indirectly (For example, using wire, wireless, etc.) connected and implemented using these multiple devices. The functional block may be implemented using the single device or the multiple devices combined with software.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that functions transmission is called a transmission unit (transmitting unit) or a transmitter. As described above, the method of realization of both is not particularly limited.

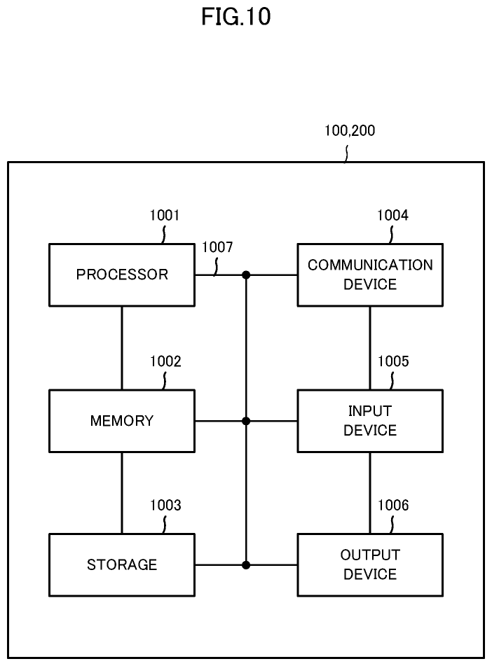

In addition, the above-mentioned gNB100 and UE200 (the device) may function as a computer for processing the radio communication method of the present disclosure. FIG. 10 is a diagram showing an example of a hardware configuration of the device. As shown in FIG. 10, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. The hardware configuration of the device may be configured to include one or more of the devices shown in the figure, or may be configured to include no part of the devices.

Each functional block of the device (see FIG. 4) is implemented by any hardware element of the computer device, or a combination of the hardware elements.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Furthermore, the various processes described above may be performed by one processor 1001 or may be performed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), etc. The memory 1002 may store programs (program codes), software modules, etc., which can execute the method according to one embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), etc., which may provide some or all of each functional block. For example, the processor 1001 may be implemented by using at least one of these hardware.

Information notification is not limited to the aspects/embodiments described in the present disclosure and may be performed using other methods. For example, information notification may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals, or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing procedures, sequences, flowcharts, etc. of the embodiments/embodiments described in the present disclosure may be rearranged as long as there is no conflict. For example, the method described in the present disclosure presents the elements of the various steps using an exemplary sequence and is not limited to the particular sequence presented.

The specific operation that is performed by the base station in the present disclosure may be performed by its upper node in some cases. It is apparent that in a network consisting of one or more network nodes having a base station, the various operations performed for communication with the terminal may be performed by at least one of the base station and other network nodes (Examples include, but are not limited to, MME or S-GW.) other than the base station. In the above, an example in which there is one network node other than the base station is explained; however, a combination of a plurality of other network nodes (for example, MME and S-GW) may be used.

Information and signals (information, etc.) can be output from the upper layer (or lower layer) to the lower layer (or upper layer). It may be input and output via a plurality of network nodes.

The input/output information can be stored in a specific location (for example, a memory) or can be managed in a management table. The input/output information can be overwritten, updated, or added. The information can be deleted after outputting. The inputted information can be transmitted to another device.

The determination may be based on a value represented by a single bit (0 or 1), a true or false value (Boolean: true or false), or a numerical comparison (For example, comparison with a given value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when software is transmitted from a website, server, or other remote source using at least one of wire technology (Coaxial, fiber-optic, twisted-pair, and digital subscriber lines (DSL)) and wireless technology (Infrared, microwave, etc.), at least one of these wire technology and wireless technology is included within the definition of a transmission medium.

Information, signals, or the like mentioned above may be represented by using any of a variety of different technologies. For example, data, instructions, commands, information, signals, bits, symbols, chips, etc. that may be referred to throughout the above description may be represented by voltage, current, electromagnetic waves, magnetic fields or magnetic particles, light fields or photons, or any combination thereof.

The terms described in the present disclosure and those necessary for understanding the present disclosure may be replaced with terms having the same or similar meanings. For example, at least one of a channel and a symbol may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station may contain one or more (For example, three) cells, also called sectors. In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a base station performing communication services in this coverage and a portion or the entire coverage area of at least one of the base station subsystems.

In the present disclosure, the terms “mobile station (Mobile Station: MS),” “user terminal,” “user equipment (User Equipment: UE),” “terminal” and the like can be used interchangeably.

A mobile station may also be referred to by one of ordinary skill in the art as a subscriber station, mobile unit, subscriber unit, wireless unit, remote unit, mobile device, wireless device, radio communication device, remote device, mobile subscriber station, access terminal, mobile terminal, wireless terminal, remote terminal, handset, user agent, mobile client, client, or some other appropriate term.

At least one of a base station and a mobile station may be called a transmitting device, a receiving device, a communication device, or the e like. Note that, at least one of a base station and a mobile station may be a device mounted on a moving body, a moving body itself, or the like. The mobile may be a vehicle (For example, cars, planes, etc.), an unmanned mobile (For example, drones, self-driving cars), or a robot (manned or unmanned). At least one of a base station and a mobile station can be a device that does not necessarily move during the communication operation. For example, at least one of a base station and a mobile station may be an Internet of Things (IOT) device such as a sensor.

The base station in the present disclosure may be read as a mobile station (user terminal, hereinafter the same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, terms an uplink channel, a downlink channel, or the like may be read as a side channel.

Similarly, the mobile station in the present disclosure may be replaced with a base station. In this case, the base station may have the function of the mobile stat ion.

The radio frame may be composed of one or more frames in the time domain. Each frame or frames in the time domain may be called a subframe.

The subframes may also be composed of one or more slots in the time domain. The subframes may be of a fixed time length (For example, 1 ms) independent of numerology.

The numerology may be a communication parameter applied to at least one of the transmission and reception of a signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like. The slot may consist of one or more symbols (Orthogonal Frequency Division Multiplexing (OFDM)) symbols, Single Carrier Frequency Division Multiple Access (SC-FDMA) symbols, etc., in tin the time domain. A slot may be a unit of time based on the numerology.

A slot may include a plurality of minis lots. Each minislot may consist of one or more symbols in the time domain. A minis lot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using the minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be referred to as a transmission time interval (TTI), a plurality of consecutive subframes may be referred to as a TTI, and one slot or minislot may be referred to as a TTI. That is, at least one of the subframes and the TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called a TTI, one or more TTIs (That is, one or more slots or one or more minislots) may be the minimum time unit for scheduling. The number of slots (number of minislots) constituting the minimum time unit for scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTIs shorter than the normal TTI may be referred to as shortened TTI, short TTI, partial or fractional TTI, shortened subframe, short subframe, minislot, subslot, slot, etc.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

A resource block (RB) is a time domain and frequency domain resource allocation unit and may include one or more consecutive subcarriers in the frequency domain. The number of subcarriers included in RB may be, for example, twelve, and the same regardless of the topology. The number of subcarriers included in the RB may be determined based on the neurology.

The time domain of the RB may also include one or more symbols and may be one slot, one minislot, one subframe, or one TTI in length. The one TTI, one subframe, and the like may each consist of one or more resource blocks.

The one or more RBs may be called physical resource blocks (PRBs), sub-carrier groups (SCGs), resource element groups (REGs), PRB pairs, RB pairs, and the like.

The resource block may be composed of one or more resource elements (REs). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by the index of the RB relative to the common reference point of the carrier. PRB may be defined in BWP and numbered within that BWP.

BWP may include UL BWP (UL BWP) and DL BWP (DL BWP). For the UE, one or more BWPs may be set in one carrier.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in the radio frame, the number of slots per subframe or radio frame, the number of minislots included in the slot, the number of symbols and RBs included in the slot or minislot, the number of subcarriers included in the RB, and the number of symbols in the TTI, the symbol length, the cyclic prefix (CP) length, and the like can be varied.

The terms “connected” and “coupled,” or any variation thereof, mean any direct or indirect connection or coupling between two or more elements, and can include the presence of one or more intermediate elements between two elements “connected” or “coupled” to each other. The connection or coupling between elements may be physical, logical, or a combination thereof. For example, “connection” may be read as “access.” As used in the present disclosure, the two elements can be considered to be “connected” or “coupled” to each other using at least one of one or more wire, cable, and printed electrical connections and, as some non-limiting and non-inclusive examples, electromagnetic energy having wavelengths in the radio frequency, microwave, and optical (both visible and invisible) regions.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

No reference to elements using designations such as “first” and “second” as used in the present disclosure generally limits the quantity or order of those elements. Such designations can be used in the present disclosure as a convenient way to distinguish between two or more elements. Accordingly, reference to the first and second elements does not imply that only two elements may be employed therein, or that the first element must in any way precede the second element.

In the present disclosure, the used terms “include,” “including,” and variants thereof are intended to be inclusive in a manner similar to the term “comprising.” Furthermore, it is intended that the term “or (or)” as used in the present disclosure is not an exclusive OR.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 Radio communication system
20 NG-RAN
100 gNB
110 Reception unit
120 Transmission unit
130 Control unit
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus

1. A terminal comprising:
a transmission unit that transmits one or more uplink channels; and
a control unit that multiplexes the one or more uplink channels; wherein
the control unit determines the one or more uplink channels based on a specific priority so that a transmission power of the one or more uplink channels is smaller than a specific power; and
the specific priority is defined based on at least one of a condition among a priority of an uplink channel, a type of the uplink channel, a priority of uplink control information transmitted through the uplink channel, and a type of the uplink control information.

2. The terminal of claim 1, wherein
the specific priority is defined based on the condition to determine the one or more uplink channels based on other condition after determining the one or more uplink channels based on the priority of the uplink channel.

3. The terminal of claim 1, wherein
the specific priority is defined based on the condition to determine the one or more uplink channels based on other condition after determining the one or more uplink channels based on the priority of the uplink control information.

4. A radio communication system comprising:
a terminal; and
a base station; wherein
the terminal comprises:
a transmission unit that transmits one or more uplink channels; and
a control unit that multiplexes the one or more uplink channels; wherein
the control unit determines the one or more uplink channels based on a specific priority so that a transmission power of the one or more uplink channels is smaller than a specific power; and
the specific priority is defined based on at least one of a condition among a priority of an uplink channel, a type of the uplink channel, a priority of uplink control information transmitted through the uplink channel, and a type of the uplink control information.

5. A radio communication method comprising:
a step A of transmitting one or more uplink channels; and
a step B of multiplexing the one or more uplink channels; wherein
the step B includes a step of determining the one or more uplink channels based on a specific priority so that a transmission power of the one or more uplink channels is smaller than a specific power; and
the specific priority is defined based on at least one of a condition among a priority of an uplink channel, a type of the uplink channel, a priority of uplink control information transmitted through the uplink channel, and a type of the uplink control information.
